(19) United States
(12) Patent Application Publication
(10) Pub. No.: US 2019/0208756 A1
(43) Pub. Date: Jul. 11, 2019

(54) FISHING LURE

(71) Applicant: Satoshi Ichiyanagi, Los Angeles, CA (US)

(72) Inventor: Satoshi Ichiyanagi, Los Angeles, CA (US)

(21) Appl. No.: 15/868,778

(22) Filed: Jan. 11, 2018

(51) Int. Cl. A01K 95/00; A01K 93/00; A01K 85/00

(52) U.S. Cl. CPC A01K 95/00; A01K 85/00; A01K 93/00

(57) ABSTRACT

A fishing lure having a body including a nose, a tail, a topside and a bottom side comprises an eyelet to connect a fishing line, a sinker including a first sinker and a second sinker, the sinker being secured in a cavity in the bottom side near the nose, the weights of the first and the second sinkers being determined so that the lure sinks with a posture that the nose position is maintained in a lower position than a tail in water when the fishing line is at rest, and a lip attached on the topside of the body and between a gravity center of the lure and the tail at an angle formed by a center line of the body and a front surface of the lip, the angle being determined between substantially 60° and 135°.

### FIELD OF THE INVENTION

The present invention relates to a field of fishing lures, particularly relates to a minnow type fishing lure having a lip.

### BACKGROUND OF THE INVENTION

There are three types of fishing lures in terms of the depth from water surface where the lure is used. A floating type is designed to swim on the surface of the water or at a limited depth of water. A suspended type lure is designed to swim at a limited depth of water. A sinking type lure is designed to swim or crawl through the water. From the view point of the lure types described above, the present invention relates to a minnow type fishing lure which may cover the floating type and the sinking type.

Basic differences between three types of fishing lures come from specific gravity of the lure. When the specific gravity of the lure is equal to or less than 1 (one), it belongs to a floating type or a suspended type of lure. When the specific gravity is more than 1 (one), it belongs to a sinking type of lure. Further, a lip attached to the lure body is used to control the swimming movements and posture of the lure body through the water when the lure body is pulled by a fishing line connected to an eyelet attached to the lure body of the fishing lure in prior arts.

There is a fishing lure that submerges with nose-down posture (or head-down) when the fishing line is at rest in the water and rises with nose-down posture in the water when the fishing line is pulled.

U.S. Pat. No. 6,484,434 discloses a fishing lure having a lip attached to a position adjacent to the nose of the body at an angle formed between the front surface of the lip and the center line of the body being substantially 45°. In this case the lip causes the lure to take a head-up posture in the water when the lure is pulled by fishing line connected to the eyelet on the nose of the body.

Japanese Utility Model No. 3040539 discloses a floating type lure having a lip attached under the nose of the body. When the fishing line is pulled through the water, the lip functions as a dive plane to cause the lure to submerge with a head-down posture. This lure is also used as a floating lure when the fishing line is at rest.

However, the lure needs to have more attractive movements, such as, natural rolling and/or wobbling of the lure body as small live fishes to attract fishes in the water. Further a fisherman or fisherwoman using a fishing rod needs to control those movements of the lure and swimming posture (swimming at a horizontal posture and/or a head-up posture when the lure is pulled by changing pulling speed and pulling strength of the lure according to the fishing locations, weather and types of target fishes.

Particularly, there are needs to freely control diving postures when resting the fishing line, and swimming postures when pulling the fishing line connected to the fishing lure weakly and/or strongly. Particularly, regarding the swimming posture of the lure, there is a need for a lure swimming horizontally in the water when retrieved from a distance in the water after casting the fishing lure with a little bit head-up posture. Further, a fisherman needs to move a fishing lure with rolling and/wobbling movements in the water after casting to attract fishes. Also, a fisherman needs to move the fishing lure to greatly deviate from the pulling direction of the fishing line connected to the eyelet attached near the nose of the body of the fishing line to attract fishes with sudden visible movements.

### SUMMARY OF THE INVENTION

An objective of the present invention is to attain the needs described above. An aspect of the present invention is a fishing lure having a body including a nose, a tail, a topside and a bottom side thereof, the fishing lure including:

at least an eyelet attached to the body for attachment of a fishing line;

a sinker including a first sinker and a second sinker, the sinker being secured in a cavity provided in the bottom side near the nose of the body, weight of the first sinker and the second sinker being determined so that the lure sinks with a posture that the nose submerges first with a lower position than the tail in water when the fishing line is at rest; and

a lip attached on the topside of the body and between a gravity center of the lure and the tail of the body at an angle formed by a center line of the body and a front surface of the lip being set between substantially 60° and 135°.

### BRIEF DESCRIPTION OF THE DRAWINGS

FIG. 1A illustrates a side view of a fishing lure according to one aspect of this invention.

FIG. 1B illustrates a side view of a fishing lure according to another aspect of this invention.

FIG. 2A illustrates a sectional view of a fishing lure viewed from the front side of the body at cutting line a-a′ of FIG. 1A according to an aspect of this invention.

FIG. 2B illustrates a sectional view of a fishing lure viewed from the front side of the body cutting line a-a′ of FIG. 1A according to another aspect of this invention having a different lip shape.

FIG. 2C illustrates a sectional view of a fishing lure viewed from the front side of the body at cutting line a-a′ of FIG. 1A according to another aspect of this invention having a different lip shape.

FIG. 3A illustrates a sectional view of a fishing lure viewed from the front side of the body at cutting line a-a′ of FIG. 1A according to another aspect of this invention having a different lip shape.

FIG. 3B illustrates a sectional view of a fishing lure viewed from the front side of the body at cutting line a-a′ of FIG. 1A according to another aspect of this invention having a different lip shape.

FIG. 4 illustrates a side view of a fishing lure according to one aspect of this invention.

FIG. 5A illustrates a sectional view of a fishing lure viewed from the front side of the body at cutting line a-a′ of FIG. 4 according to an aspect of this invention.

FIG. 5B illustrates a sectional view of a fishing lure viewed from the front side of the body at cutting line a-a′ of FIG. 4 according to another aspect of this invention.

FIG. 6A illustrates a sectional view of a fishing lure viewed from the front side of the body at cutting line a-a′ of FIG. 4 according to another aspect of this invention.

FIG. 6B illustrates a sectional view of a fishing lure viewed from the front side of the body at cutting line a-a′ of FIG. 4 according to another aspect of this invention.

FIG. 7 illustrates a side view of a fishing lure according to one aspect of this invention when the fishing lure is cast on water surface.

FIG. 8 illustrates a side view of a fishing lure according to one aspect of this invention when a fishing line is at rest.

FIG. 9 illustrates a side view of a fishing lure according to one aspect of this invention when the fishing line is pulled.

FIG. 10 illustrates a side view of a fishing lure according to one aspect of this invention when the fishing line is further pulled from a state shown in FIG. 9.

FIG. 11 illustrates moving postures of a fishing lure in the water after landing on the water surface based on the speed and pulling strength of the fishing line connected to the fishing lure at several depths of water.

FIGS. 12A, 12B and 12C illustrate rolling movements of a lure body when the fishing line is pulled.

FIG. 13A illustrates a moving posture of a fishing lure in the water when a fishing line is at rest.

FIG. 13B illustrates a moving posture of a fishing lure in the water when a fishing line is at rest in a case that first sinker is further heavier than the second sinker.

FIG. 14 illustrates a side view of a fishing lure according to one aspect of this invention when a plurality of eyelets is provided between the nose of the body and a lip.

FIG. 15 illustrates wobbling movements of a lure body when the fishing line is pulled.

FIG. 16 illustrates fishing lure movements (just like flying left and right) when the fishing lure is strongly pulled with a sudden action of the fishing rod.

FIG. 17 illustrates slipping movements of a lure body when the fishing line is pulled.

### DETAILED DESCRIPTION OF THE INVENTION

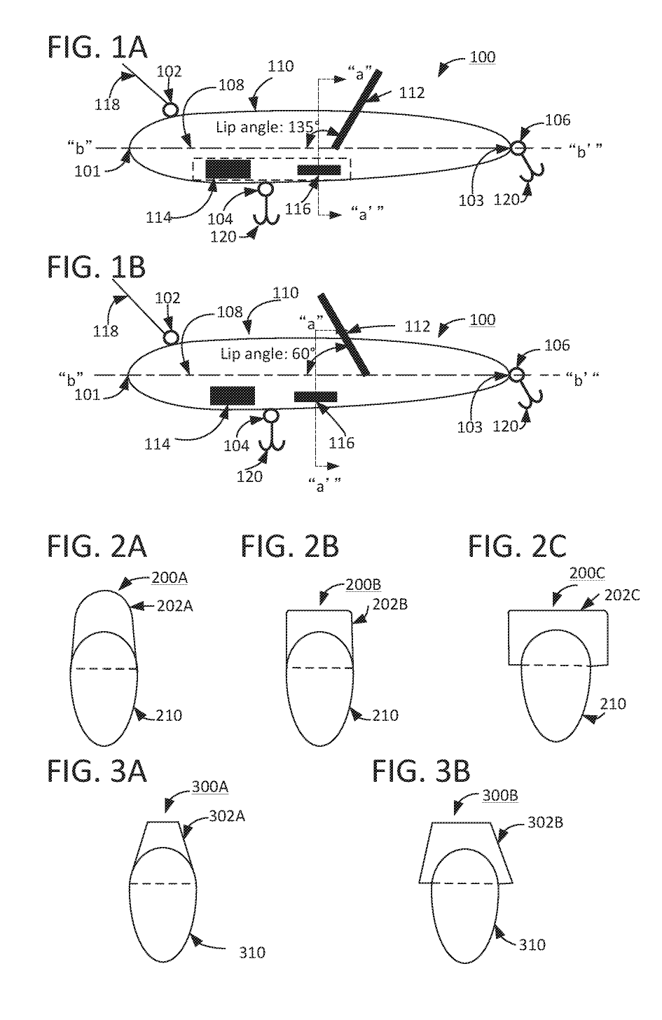

FIG. 1A illustrates a side view of a fishing lure 100 according to an aspect of this invention. The fishing lure 100 is structured by a body 110, an eyelet 102 attached upside of the body 110 and near a nose 101 and an eyelet 104 attached underside of the body 110, an eyelet 106 attached at a rear end 103 and a lip 112 attached upside of the body 110 and a sinker (shown in a rectangular in dotted line) including first sinker 114 and second sinker 116 installed in a space provided underside of the body 110. Further hooks 120 are connected on the eyelets 104 and 106 respectively.

In this embodiment of the present invention, the center of gravity of the fishing lure 100 is designed to position between the nose 101 and the lip 112. In this embodiment, the position of the center of gravity of the fishing lure 100 can be identified by the followings. First, an eyelet to which a piece of string is connected is attached at a certain point on the topside of the body 110. Second, hang the body 110 by the string in the air. Third, the position of the center of gravity of the body 110 is identified by finding out the eyelet position where the center line “b-b′” (in FIG. 1A) is balanced in the horizontal direction against the gravity when hanging the fishing lure 100 in the air by lifting up the fishing lure 100 by the string. Since the center of gravity of the fishing lure 100 is arranged to position between the nose 101 and the lip 112 when viewed from above the lure, the fishing lure 100 submerges with a posture that the nose 101 sinks in the first (head-down posture) and the rear end 103 sinks in the second into the water when fishing line 118 connected to eyelet 102 is at rest in the water. Further, since the center of gravity of the lure 100 is designed to positioned between the nose 101 and the lip 112, as a result, the hook 120 connected to eyelet 104 is to position near the center of gravity of the fishing lure 100. The weight of the the first sinker 114 is heavier than that of the second sinker 116. The first sinker 114 and the second sinker 116 are structured by lead with this embodiment.

The lip 112 is attached on the upside of the lure body 110 and between the center of gravity of the fishing lure 100 and rear end 103 of the lure body 110 at an angle formed by the front surface of the lip 112 and the center line “b”-“b′” being set between substantially 60 degrees and 135 degrees as illustrated in FIGS. 1A and 1B. The line “a”-“a′” is positioned in the mechanical center of the fishing body 110 in a longitudinal direction of the body 110. The lip 112 can also be attached on the upside of the lure body 110 and between the mechanical center of the center line of the body 110 and the rear end 103 of the lure body 110. The lip 112 is structured by carbon plate in this embodiment, but not limited. For Example, it may be a plastic plate or a metal plate, such as an aluminum plate.

FIG. 1B illustrates a side view of the fishing lure 100 according to another aspect of this invention when the lip 112 is set at an angle formed between the front surface of the lip 112 and the center line “b”-“b′” being set at substantially 60 degrees as described above.

### Rolling Movements

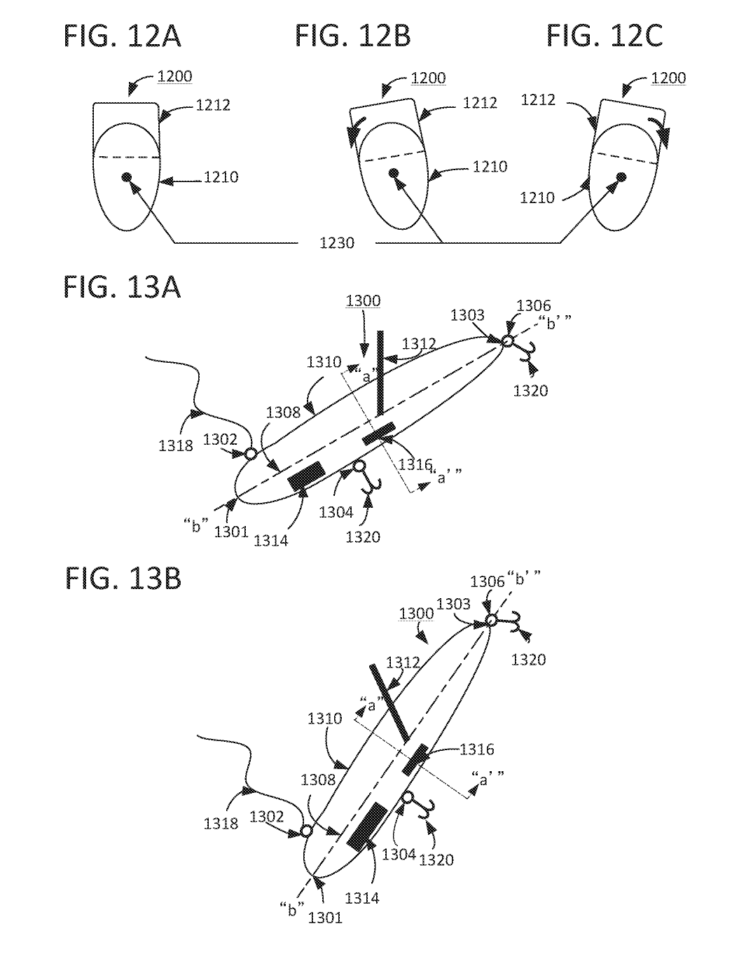

Referring to FIGS. 12A, 12B and 12C, rolling movements of the fishing lure will be described. Followings are experimental results of fishing lures 1200 as illustrated in FIGS. 12A, 12B and 12C. The front surface of the lip 1212 is designed to receive resistance of water flow when the fishing lure 1200 is pulled forward. When the lip 1212 is attached obliquely toward the rear direction as illustrated in FIG. 1A, the fishing lure 1200 slightly rolls into left and right directions centering on the substantially center 1230 of the body 1210 viewed from the point in front of the body 1210 as illustrated in FIGS. 12A, 12B and 12C (this movements are called rolling movements in this specification). The amplitude and frequencies of the rolling movements of lure 1200 increases as the pulling strength or speed increases.

### Wobbling Movements

The wobbling movements will be described below using FIG. 15, which illustrates wobbling movements of a fishing lure 1500 having a lip 1512 attached obliquely toward the front direction as illustrated in FIG. 1B. When a fishing line 1518 connected to an eyelet attached near the nose 1501 is pulled, due to the water pressure against the lip 1512, the lure 1500 wobbles the nose 1501 into left and right directions viewed from the point in front of the nose 1501 while keeping track on pulling direction by the fishing line 1518 as illustrated in FIG. 15. In this embodiment, this movement is called “wobbling movements”. The height of the lip is higher, the more wobbling movements and more headup posture for swimming toward the surface of water tend to occur. The amplitude of wobbling movement of the nose 1501 is small and not so visible. The wobbling movements may occur when the lip 1512 attached obliquely toward the rear direction as illustrated in FIG. 1A. However, the wobbling movements occurred in this case is smaller than that of lure having the lip 1512 attached obliquely toward the front direction as illustrated in FIG. 1B. Wobbling movements are added to the rolling movements described above.

Back to FIG. 1B, when the lip 112 is attached on the topside of the body 110 obliquely toward the nose 101 as illustrated in FIG. 1B, more wobbling movements occur comparing with that of fishing lure illustrated in FIG. 1A. The body 110 of the fishing lure 100 wobbles as illustrated in FIG. 15 as described. Wobbling movements are added to the rolling movement described above. In other words, when the fishing lure 100 is pulled by the fishing line 118, the fishing lure 100 rolls into left and right directions centering on the substantially center of the body viewed from the point in front of the body as illustrated in FIGS. 12A, 12B and 12C while the fishing lure 100 swims on a pulling direction of the lure 100, wobbling movements occur in addition to the rolling movements, which wobble the the nose 101 into left and right directions viewed from the point in front of the nose 101 of the body 110 with a small amplitude as illustrated in FIG. 15.

Back to FIGS. 1A and 1B, the lip angle formed by the front surface of the lip 112 and the center line “b”-“b′” is set between substantially 60° (degrees) and 135° (degrees), preferably between substantially 80° (degrees) to 120° (degrees) and more preferably between substantially 100° (degrees) to 120 degrees. Water pressure against the front surface of lip 112 generated by the water flow when pulling fishing line 118 connected to the eyelet 102 changes according to the set angle formed by the front surface of the lip 112 and the center line “b”-“b′” and the pulling speed or pulling strength of the fishing line 118. Since the front surface of the lip 112 illustrated in FIG. 1B can catch more water pressure than that of lip 112 illustrated in FIG. 1A, the water pressure against the front surface of the lip 112 causes the rear side of body 110 to be pushed downward, the fishing lure 110 illustrated in FIG. 1B can swim toward the water surface with steeper angle against the vertical line than that of lure 110 illustrated in FIG. 1A.

Total five shapes of lip 112 are illustrated in FIGS. 2A-2C, 3A and 3B respectively. FIG. 2A illustrates a sectional view of a fishing lure 100 illustrated in FIGS. 1A and 1B when viewing at cutting line a-a′ of FIGS. 1A and 1B.

The fishing lure 100 is designed to swim or move through the water in a head-down posture without the lip 112 when pulling the fishing line 118 connected to the eyelet 102 attached on the upside of the nose 101. When attaching the lip 112 on the topside and between the center of gravity of the fishing lure 100 and rear end 103 of the lure body 110 at an angle formed by the front surface of the lip 112 and the center line “b”-“b′” being set between substantially 60 degrees and 135 degrees as illustrated in FIGS. 1A and 1B as illustrated in FIGS. 1A and 1B, the nose 101 of the body 110 is lifted upside and pulled to the forward direction in a natural swimming posture like minnows. The lip functions not only as a tool for rolling and/or wobbling the lure itself but also functions as a tool for lifting the nose 101 of the body 110 upward.

In FIG. 2A. sectional view of a body 210 shows a shape substantially an oval shape having a narrow width in a lowerside of the body 210 and substantially circular shape in upside of the body 210. The lower width of the lip 202A has substantially the same width as the maximum width of the body 210. Top side of lip 202A has substantially a circular shape having both sides of the lip 202A being substantially a parallel to each other.

Lip 202B illustrated in FIG. 2B is shaped in a substantially rectangular shape having round shapes of the topside corners of lip 202B and having the same width as that of the maximum width of body 210.

Lip 202C illustrated in FIG. 2C is shaped in a substantially rectangular shape having round corners on the topside potions of the lip 202C and having a wider width than that of the maximum width of body 210.

FIGS. 3A and 3B illustrate lips 302A and 302B having a shape substantially trapezoid. The width of the lower side of the lip 302A illustrated in FIG. 3A has substantially the same width of the maximum width of the body 310 as illustrated in FIG. 3A. The width of the lowerside of the lip 302B illustrated in FIG. 3B is wider than that of the maximum width of body 310.

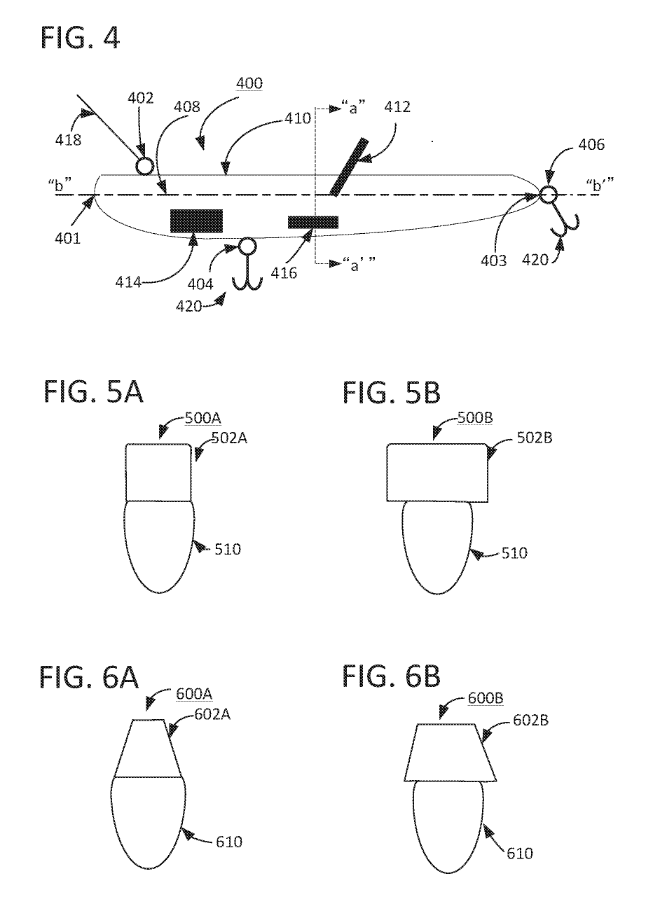

FIG. 4 illustrates a side view of a fishing lure 400 according to one aspect of this invention. In this embodiment, The topside of the body 410 is shaped in flat as illustrated in FIG. 4. FIGS. 5A and 5B illustrate cross-sectional views viewed at cutting line “a”-“a′” in FIG. 4. As illustrated in FIGS. 5A and 5B, the topside of body 510 is shaped in flat.

According to inventor's experiments conducted in actual fishing areas, when the topside of the body 410 is shaped in a flat surface, the fishing lure 400 swims substantially straight when fishing line 418 is pulled by relatively strong strength comparing with the swimming of the fishing lures illustrated in FIGS. 1A and 1B. In the case of fishing lure having a flat surface of the topside of the body as illustrated in FIG. 4, unexpected lift-up movements of the lure body which tend to occur when initially pulling the fishing lure, can be suppressed. Other movements of the fishing lure are same as the movement of the fishing lures illustrated in FIGS. 1A and 1B.

Lip 502A illustrated in FIG. 5A is shaped in a substantially rectangular shape having round corners on the topside portions of lip 502A and having the same width as that of the maximum width of the body 510.

Lip 502B illustrated in FIG. 5B is shaped in substantially a rectangular shape having round corners on the topside potions of the lip 502B and having a wider width than that of the maximum width of body 510.

FIGS. 6A and 6B illustrate lips 602A and 602B having a shape substantially trapezoid. Lip 602A illustrated in FIG. 6A has substantially the same width of the lower side of the lip 602A as the width of the maximum body width of body 610. Lip 602B illustrated in FIG. 6B has a lip having a wider width of the lowerside of the lip 602B than that of the maximum width of body 610.

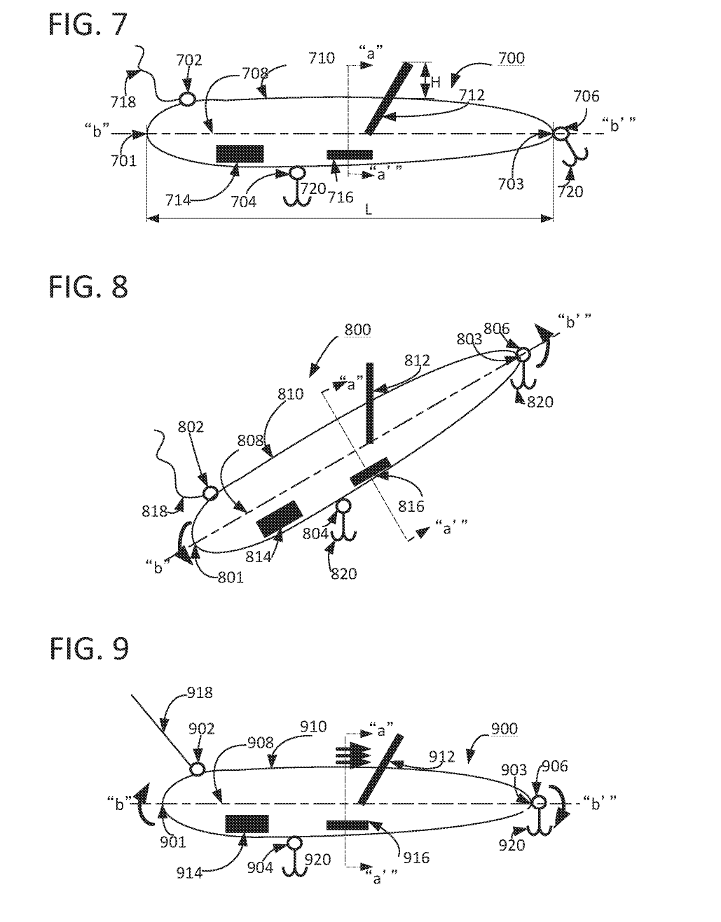

FIG. 7 illustrates a fishing lure posture immediately after the fishing lure 700 has landed on the water surface after being cast. When landing on the water surface, the fishing lure 700 start sinking.

Then, the fishing lure 800 illustrated in FIG. 8 starts sinking with a posture that the nose 801 of the body 810 moves downward centering on the center of gravity of the fishing lure 800 located between the nose 801 and the lip 812 (a head-down posture) when the fishing line 818 is at rest. The fishing lure 800 starts sinking into the water while rolling (as illustrated in FIGS. 12A-12C) and wobbling (as illustrated in FIG. 15) the body 810 as illustrated in FIG. 8.

When the fishing line 918 connected to eyelet 902 is pulled as illustrated in FIG. 9, water resistance against lip 912 causes the lure body 910 to rotate so that the nose 901 of body 910 moves upward and the rear end 903 moves down. As a result, the lure body 910 takes a horizontal posture as illustrated in FIG. 9. Then when fishing line 918 is pulled with a relatively weak strength, the fishing lure 900 moves forward while keeping the body 910 in substantially a horizontal direction in the water.

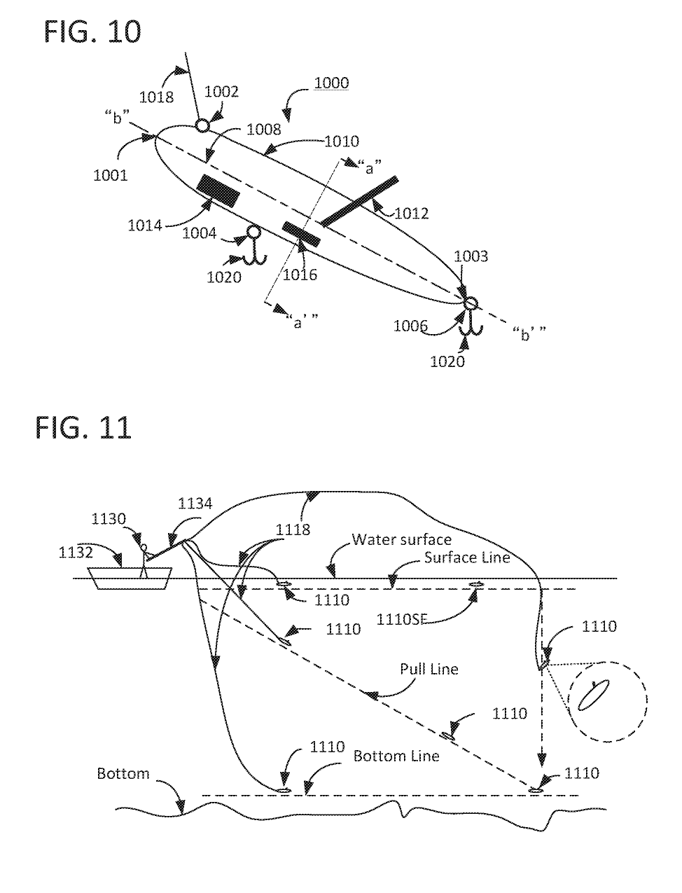

FIG. 10 illustrates a side view of a fishing lure 1000 when the fishing line 1018 is further pulled from a state shown in FIG. 9. In this case, the lip 1012 causes the nose 1001 to move upward in the water when the fishing line 1018 is further pulled. One embodiment of the present invention, the height of the lip is set at 18 mm. When the height of lip increase, the nose 1001 faces upward with a steeper angle against the vertical direction because the front surface of the lip receives more water pressure and the water pressure causes the tail portion of the body to push down. Further, the height of the lip increases, more wobbling movements (amplitude and pitch of the wobbling movements) occur.

As described above, a fisherman or fisherwoman can freely control the lure by controlling the pulling speed and/or pulling strength of the lure to submerge the lure 1000 into downward with a head-down posture, to swim the fishing lure 1000 in a horizontal direction (maintain the lure 1000 at a certain depth of water) and to swim the lure 1000 toward the water surface with rolling movements, wobbling movements and/or sudden deviation of the lure from the pulling direction, which will be described later. As a result, this lure can attract fishes.

### Swimming Posture

An embodiment of the present invention is a lure that is designed to sink through the water after landing on the water surface. FIG. 11 illustrates swimming aspects of a fishing lure 1110 after casting the fishing lure on the water surface. When the fishing lure 1110 lands on the water surface and the fishing line 1118 is at rest, the fishing lure 1110 starts sinking with a nose first posture (a headdown posture) as described above. Here “nose first” means that the fishing lure 1110 submerges through the water with a posture that the nose of the body sinks earlier than the tail of the body as shown in doted circle in FIG. 11. In this instance, the fishing lure 1110 submerges through the water with rolling movements as illustrated in FIGS. 12A-12C.

When a fisherman or a fisherwoman pulls the fishing line of the fishing lure before the fishing lure 1110 starts sinking, the fishing lure 1110 swims along with the water surface toward the boat 1132 with rolling movements (referring to FIGS. 12A-12C) and/or wobbling movements (referring to FIG. 15) as illustrated in FIG. 11. When pulling the fishing lure 1110 with higher speed, then the rolling and wobbling pitch (frequency) increases. This example shows that the fishing lure 1110 swims along the surface of the water. However, it is also possible to swim the fishing lure 1110 at a certain depth of the water in a substantially horizontal direction.

When the fishing line 1118 is pulled after the fishing lure 1110 arrives the bottom of the water, the fishing lure 1110 moves toward the boat 1132 with a posture that the nose of the body positions higher than the tail of body along with a doted slant line as illustrated in FIG. 11. This is because the water pressure to the surface of the lip causes the tail of body to push down as described above. As described above, when pulling the fishing lure 1110 with a higher speed, the fishing lure 1110 rolls and wobbles with a higher frequency.

when the fishing line 1118 is weakly pulled after the fishing lure 1110 has arrived on the bottom of the water, fishing lure 1110 can swim or crawl along with the bottom of the water with rolling and wobbling movements having a low frequency as illustrated in FIG. 11.

As described above, according to an aspect of the present invention, it becomes possible to freely control diving postures and swimming postures when resting the fishing line or weakly or strongly pulling the fishing line connected to the fishing lure.

### Rolling Movements of Lure Body

FIGS. 12A, 12B and 12C illustrate rolling movements of a fishing lure 1200 when the fishing line is pulled. In FIGS. 12A, 12B and 12C, the rolling movements will be explained by using cross section views of the lure body 1210 viewed at substantially middle point of the longitudinal direction of the body as illustrated in FIG. 1A.

In case that no lip is attached on the upside or topside of the body 1210, the fishing lure 1200 sinks in the water with a posture that the position of the nose of the body is lower than the tail of the body even when the lure line is pulled. This is because that the center of gravity of the fishing lure is positioned between the nose and the lip and underside of the lure body. In case that the lip is attached to the rear side of the body or on the second half of the body or between the center of the gravity of the lure and the tail of the body as illustrated in FIG. 1, the water pressure against the lip surface causes the nose of the body to move upward when the fishing line is pulled. In other word, the lip works as a tool for lifting up the nose of the body.

When the fishing lure is at a rest condition, (the fishing line is not pulled), the nose of the body tends to move downward through the water even though the water pressure against the lip surface causes the nose portion to rise. When the fishing line is pulled, the nose of the body moves upward. As a result, the water pressure against the lip 1212 further causes the nose of the body to rise.

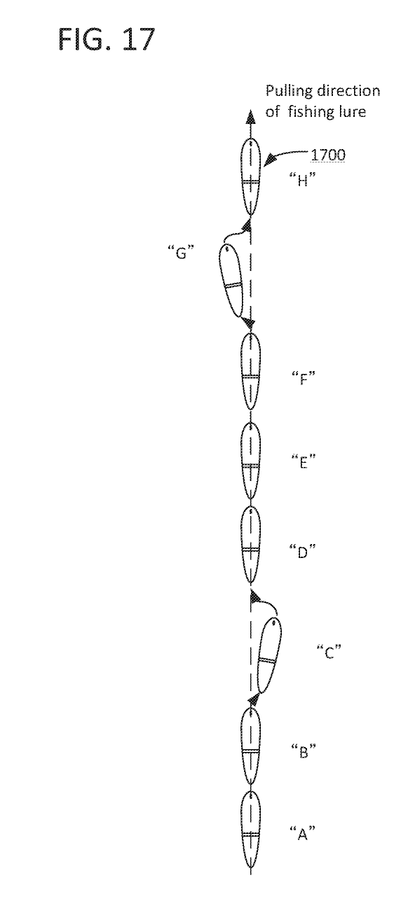

Accordingly, when pulling the fishing lure with more stronger strength than normal strength, the lure body movements become unbalanced. As a result, the body deviates randomly from the pulling direction of the fishing line connected to the eyelet attached near the nose of the body as illustrated in FIG. 17 in addition to the rolling movements. The inventor of this invention names the movements described above “slipping movements”.

In this specification, the inventor of this invention has divided the pulling strength of the fishing lure into following five levels.

Level 1: Fishing lure is pulled with extremely weak strength.

Level 2: Fishing lure is pulled with a slow speed but stronger strength than that of level 1.

Level 3: Fishing lure is pulled with a normal speed.

Level 4: Fishing lure is pulled with stronger strength than that of normal speed.

Level 5: Fishing lure is suddenly pulled with a strongest strength so that the top portion of the fishing rod is curved.

Level 1: When the fishing lure is pulled with an extremely slow speed, the lure body rolls in left and right directions slowly in a low pitch (in a low frequency) centering on the center 1230 of the lure body 1210 viewed from the point in front of the nose of the body as illustrated in FIGS. 12A-12C. In this instance, the main movement is rolling movements. However, there are some cases that wobbling movements having a small amplitude are included in the body movements (referring to FIG. 15).

Level 2: Then, when the fishing lure is pulled with a slow speed (a little bit faster than the speed of Level 1), the fishing lure swims with rolling movements that the fishing lure rotates left and right directions centering on the longitudinal axis of the body with small amplitude and swims in a substantially straight direction with a little bit higher pitch comparing to that of level 1. In this case, as described above, wobbling movements having a small amplitude are included in the body movements.

Level 3: When the fishing lure is pulled with a normal speed, the lure body remains in a substantially horizontal posture. In other words, the lure swims at a certain depth of water with a horizontal posture and the body rolls into left and right in small amplitude with a higher pitch or frequency centering on the substantially center of the body viewed from the point in front of the nose of the body comparing with level 2 as illustrated in FIGS. 12A, 12B and 12C. In this case, as described above, the body movements include wobbling movements having a small amplitude with a little bit higher pitch or frequency comparing with level 2. In this case, the fishing lure swims with a posture that the nose of the lure body is raised a little bit. On this level 3, sometimes the lure rapidly loses body balance and the body starts slipping movements that the fishing lure slightly slips off randomly from the pulling direction of the fishing line connected to the eyelet attached near the nose of the body as illustrated in FIG. 17. Regarding the slipping movements, it will be described later.

Level 4: When the fishing lure is pulled with a further stronger strength, the amplitude and the pitch of the rolling movements and wobbling movements increase comparing with level 3 and the fishing lure sometimes loses the body balance due to the stronger water pressure to the lip. There are some cases that the fishing lure loses the body balance and the lure body starts slipping movements that the fishing lure slightly and randomly slips off from the pulling direction of the fishing line connected to the eyelet attached near the nose of the body as illustrated in FIG. 17. FIG. 17 illustrates a situation where fishing lure 1700 positioned “A” is pulled and moved toward position “H” by the fishing line. The fishing lure 1700 slightly slips off from the pulling direction shown in dotted line at positions “C” and “G” in this example when losing balance of the body. Inventor names this movement “slipping movements”. From level 1 to level 4, the main body movements are rolling movements, and some wobbling movements are included in addition to the rolling movements.

Level 5: When the top portion of a fishing rod is strongly pulled with a sudden action, the fishing lure greatly deviates from the pulling direction of the fishing line connected to the eyelet attached near the nose of the body of the fishing line. The fishing lure moves into random directions just like flying left and right in the water as illustrated in FIG. 16. In FIG. 16, when the fishing lure located at position “A” is strongly pulled with a sudden action of the fishing rod as described above, the fishing lure greatly deviates from the pulling direction and moves to position B from position A. Then, the next sudden action is applied to the fishing rod, the fishing lure randomly moves from position “C” to ‘position “D” just like flying left and right.

### Sinker and Posture in the Water

FIGS. 13A and 13B illustrate the postures of a fishing lure sinking in the water with regard to weight differences between the weight of the first sinker 1314 and that of the second sinker 1316 when the fishing line 1318 is at a rest condition.

As described above, the lure body 1310 is structured by balsawood having a specific gravity being less than 1 (one). The lure body 1310 may be structured by plastic material or the same. The weight of sinkers 1314 and 1316 structured by lead is determined so that the fishing lure 1300 is designed to sink with the nose down posture (head-down posture) in the water when the fishing line 1318 is at a rest condition. In this embodiments, the weight of sinker 1314 is heavier than that of sinker 1316.

When a fisherman or a fisherwoman needs to sink the fishing lure in a steeply inclined posture in the water as illustrated in FIG. 13B, more heavier weight of the sinker 1314 is selected comparing with the weight of the sinker 1316. The balance between weights of sinkers 1314 and 1316 can be determined based on the conditions of the fishing place. The angle formed by the horizontal line in the water and the center line of the lure body increases when the weight of the first sinker located in front of the second sinker is heavier than that of the second one. In this case, the sinking speed of the lure in the water can also increase.

### Multiple Eyelets

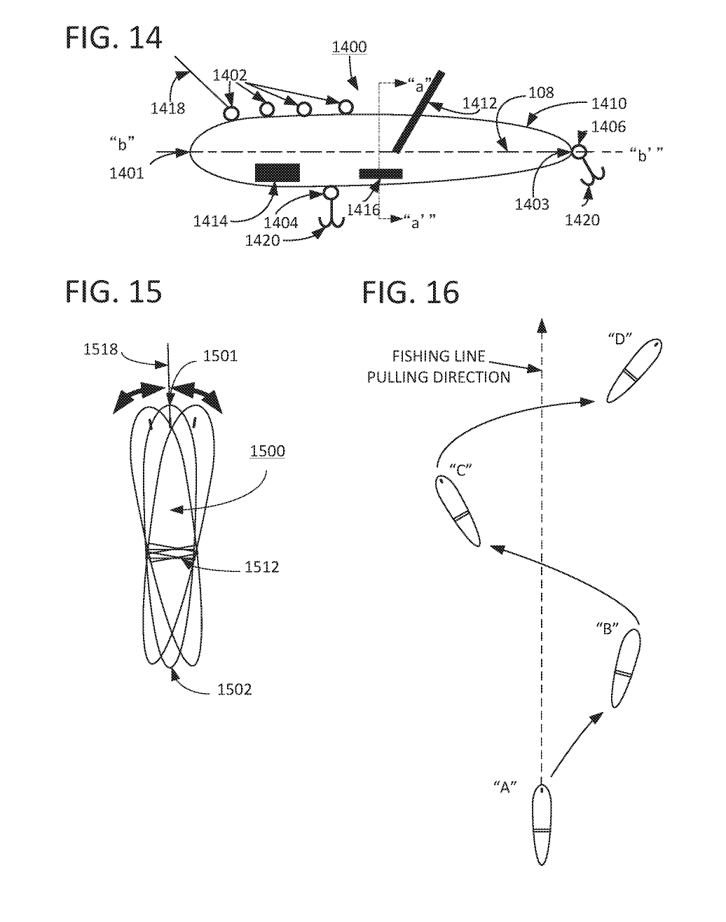

Movements of the fishing lure in the water changes when changing the position of the eyelet with which a fishing line is tied as illustrated in FIG. 14. According to an inventor's experiments, the frequency of the rolling actions and wobbling actions of the lure goes up as the position of the eyelet 1402 with which the fishing line 1418 is tied approaches from the front portion toward the rear portion of the lure body 1410. In an embodiment of the present invention, total four eyelets 1402 are attached on the upside of the body, but not limited to this. It may be two, three or five or more.

### Size and Materials of Example

Followings are materials and sizes of each parts used in this experiment.

Lure Body: balsawood

Lip: Carbon plate

Eyelet: Stainless steal

Sinker: Lead

The size of the lure body: Length; 80 mm, Maximum Height; 18 mm and Width of body; 13 mm

Height of Lip: 18 mm

These materials and sizes of the fishing lure are not limited to those described above. For example, back to FIG. 7, a length L of the lure body 710 can be set between 30 mm to 300 mm in this embodiment. As for the height H of the lip 712 which protruded from the surface of the topside of the lure body 710 to the top edge of the lip 712 can be set between 5 mm to 60 mm in this embodiment

What is claimed is:

1. A fishing lure having a body including a nose, a tail, a topside and a bottom side thereof, the fishing lure comprising:
at least an eyelet attached to the body for attachment of a fishing line;
a sinker including a first sinker and a second sinker, the sinker being secured in a cavity provided in the bottom side near the nose of the body, weight of the first sinker and the second sinker being determined so that the fishing lure sinks with a posture that the nose submerges first with a lower position than the tail in water when the fishing line is at rest; and
a lip attached on the topside of the body and between center of gravity of the fishing lure and the tail of the body at an angle formed by a center line of the body and a front surface of the lip being set between substantially 60° and 135°.

2. The fishing lure according to claim 1 wherein the center of gravity of the fishing lure is positioned between the nose and the lip.

3. The fishing lure according to claim 1 wherein the angle is preferably set between substantially 80 degrees to 120 degrees.

4. The fishing lure according to claim 1 wherein the angle is preferably set between substantially 100 degrees to 120 degrees.

5. The fishing lure according to claim 1 wherein the eyelet is attached to the body of the fishing lure between the nose and the lip.

6. The fishing lure according to claim 1 further comparing:
a plurality of eyelets attached to the body of the fishing lure between the nose and the lip.

7. The fishing lure according to claim 1 wherein the body includes a first fish hook at the tail of the body.

8. The fishing lure according to claim 7 wherein the body includes a second fish hook at the bottom side of the body and between the first sinker and the second sinker.

9. The fishing lure according to claim 1 wherein the body is structured by a material including balsawood.

10. The fishing lure according to claim 1 wherein the lip is structured by a material including carbon plate.

11. The fishing lure according to claim 1 wherein the sinker is structured by a material including lead.

12. The fishing lure according to claim 1 wherein the weight of the first sinker is heavier than that of the second sinker.

13. The fishing lure according to claim 1 wherein the lip has a substantially rectangular shape including a substantially flat surface, two corners of topside of the rectangular shape being rounded.
